(19) United States
(12) Patent Application Publication
(10) Pub. No.: US 2026/0119738 A1
(43) Pub. Date: Apr. 30, 2026

(54) METHOD FOR OPTIMIZING LAYOUT OF WATER NETWORK SYSTEM

(71) Applicant: MWR GENERAL INSTITUTE OF WATER RESOURCES AND HYDROPOWER PLANNING AND DESIGN, Beijing (CN)

(72) Inventors: Weifeng LIU, Beijing (CN); Xuning GUO, Beijing (CN); Yunling LI, Beijing (CN); Yuanyuan LI, Beijing (CN); Feilin ZHU, Beijing (CN); Xiang ZENG, Beijing (CN); Shaoming PENG, Beijing (CN); Qiubo SONG, Beijing (CN); Xinyang LI, Beijing (CN); Guanghua GUAN, Beijing (CN)

(21) Appl. No.: 19/305,898

(22) Filed: Aug. 21, 2025

(30) Foreign Application Priority Data
Oct. 24, 2024 (CN) 202411487782.6

(51) Int. Cl. G06F 30/20; G06F 30/18; G06F 111/10

(52) U.S. Cl. CPC G06F 30/20; G06F 30/18; G06F 2111/10

(57) ABSTRACT

A method and a system for optimizing the layout of a water network system are provided, including: collecting data of the study area, calculating DEM accuracy and optimal catchment area threshold, identifying watersheds in the study area, dividing the study area into several first-level basins and second-level basins; calculating domestic, industrial, agricultural and ecological water demands of each basin; constructing a system dynamics model of the water network system, calculating mutation points of capacity building efficiency indicators, obtaining an optimal layout scheme of nodes and corresponding water supply; constructing a water resources optimal allocation model, optimizing parameters of the system dynamics model, obtaining an optimal layout scheme of first-level basins; calculating differences between water supply and water demand of each first-level basin, inputting the differences into a pre-constructed water resources optimal scheduling model, obtaining a water resources optimal scheduling scheme for the study area.

### CROSS-REFERENCE TO RELATED APPLICATIONS

This application claims priority to Chinese Patent Application No. 202411487782.6, filed on Oct. 24, 2024, the contents of which are hereby incorporated by reference.

### TECHNICAL FIELD

The disclosure relates to a method for optimizing the layout of a water network system.

### BACKGROUND

A water network system is a comprehensive system that takes natural rivers and lakes as the foundation, water diversion, drainage and water transfer projects as channels, regulation and storage projects as nodes, and intelligent regulation as means, integrating functions such as optimal allocation of water resources, flood control and disaster reduction in river basins, and protection of aquatic ecosystems. It is an effective measure to solve the uneven spatial distribution of water resources, improve the water resource guarantee rate in water-receiving areas, alleviate the contradiction between supply and demand of water resources in water-scarce areas, and realize the rational allocation of water resources, and is an important way to promote economic development and comprehensive development and utilization of water resources in water-scarce areas.

With the impact of factors such as population growth, accelerated urbanization and climate change, the contradiction between supply and demand of water resources has become increasingly prominent. Optimizing the layout of the water network system may effectively adjust the supply and demand relationship of water resources, meet different water demands, reduce the risk of floods, droughts and other water disasters, maintain the ecological balance of water bodies, protect the health of ecosystems, maximize the economic benefits of water resources, reduce operating costs, improve resource utilization efficiency, and promote the sustainable utilization of water resources.

The disclosure provides a method for optimizing the layout of a water network system, so as to form a national river basin and regional water network optimization layout scheme oriented to medium and long-term water resource security guarantee, put forward suggestions on the layout of major projects and related measures, and reduce project construction costs.

### SUMMARY

Objective of the disclosure: providing a method for optimizing the layout of a water network system to solve the above-mentioned problems existing in the prior art. On the other hand, providing a system for optimizing the layout of a water network system.

Technical solution: a method for optimizing the layout of a water network system includes following steps:
step S1: collecting data of the study area, calculating digital elevation model (DEM) accuracy and optimal catchment area threshold based on topographic data of the study area, gridding the study area and automatically identifying watersheds boundaries in the study area, dividing the study area into m first-level basins based on the watersheds, each basin containing several second-level basins, where m is a positive integer greater than 2;
step S2: extracting domestic, industrial, agricultural and ecological water demands of each administrative division in the study area, sequentially calculating the ratio of the number of grids in each second-level basin of each first-level basin to the total number of grids of the administrative division to the second-level basin belongs, obtaining domestic, industrial, agricultural and ecological water demands of each second-level basin in each first-level basin, and sequentially summing the water demands of all second-level basins in each first-level basin to obtain domestic, industrial, agricultural and ecological water demands of each first-level basin;
step S3: constructing a system dynamics model of the water network system based on historical construction investment of each node in the study area and historical gross domestic product (GDP) total data corresponding to the node, where the nodes in the study area include: reservoirs and lakes; solving the system dynamics model to obtain a change curve of GDP with the increase of node construction investment, sequentially calculating mutation points of capacity building efficiency indicators corresponding to all nodes, and obtaining an optimal layout scheme of nodes in the water network system and corresponding water supply based on the mutation points of capacity building efficiency indicators;
step S4: extracting historical water supply, historical rainfall and historical runoff data of all second-level basins in each first-level basin, respectively inputting them into a pre-constructed water resources optimal allocation model to obtain a long-term optimal allocation scheme of all second-level basins in the first-level basin; calibrating parameters of the system dynamics model based on the long-term optimal allocation scheme; obtaining the water supply of the second-level basin based on the sum of water supplies of all nodes in the second-level basin; inputting the water supply, rainfall and runoff data of all second-level basins in the first-level basin into the optimized system dynamics model to obtain a water resources optimal allocation scheme of the first-level basin; and
step S5: sequentially calculating the difference between water supply and water demand of each of the m first-level basins based on their water supplies and water demands, inputting the differences into a pre-constructed water resources optimal scheduling model to obtain an optimal water resources scheduling scheme for the study area; the obtained optimal layout scheme of the water network system includes: the optimal layout scheme of nodes in the water network system, the water resources optimal allocation schemes of the m first-level basins, and the optimal water resources scheduling scheme of the study area.

According to one aspect of the application, the step S1 includes following steps:
step S11: collecting data of the study area, including topographic data, domestic, industrial, agricultural and ecological water demand forecasts of each administrative division, historical construction investment of nodes, historical GDP data, historical water supply forecasts, historical rainfall forecasts and historical runoff forecasts;
step S12: setting DEM accuracy based on topographic data of the study area, dividing the study area into several grids according to the DEM accuracy, and calculating the optimal catchment area threshold by using the river network density method; and
step S13: automatically identifying all watersheds in the study area based on the optimal catchment area threshold and dividing the study area into several basins; dividing the several basins into m first-level basins and n second-level basins based on whether the main river course of each basin belongs to the outline or the sub-outline in the water network system, where the first-level basin is the outline in the water network system, the second-level basin is the sub-outline in the water network system, and m and n are positive integers greater than 0.

According to one aspect of the application, the step S12 includes following steps:
step S12a: setting a variety of different DEM resolutions and calculating the river length, basin area and river network density extracted under different thresholds;
step S12b: fitting the second derivative of the river network density curve and finding the point, where the second derivative of the point is 0 to obtain the range of the optimal threshold; and
step S12c: superimposing and comparing the river network extracted under the determined optimal threshold range with the actual river network to determine the optimal thresholds under four resolutions.

According to one aspect of the application, the step S2 includes following steps:
step S21: sequentially extracting each basin, and classifying grids in the basin according to the belonged administrative division;
step S22: sequentially calculating the proportion of the number of all grids belonging to a certain administrative division in each basin to the total number of grids of the administrative division; calculating domestic, industrial, agricultural and ecological water demands of the part belonging to the administrative division in the basin, i.e., the product of the proportion and the total domestic, industrial, agricultural and ecological water demands of the administrative division;
step S23: sequentially calculating domestic, industrial, agricultural and ecological water demands of all classifications in each basin, and summing them to obtain domestic, industrial, agricultural and ecological water demands of the basin; and
step S24: performing calculations of S21-S23 on all first-level and second-level basins to obtain domestic, industrial, agricultural and ecological water demands of all first-level and second-level basins.

According to one aspect of the application, the step S3 includes following steps:
step S31: extracting historical construction investment of each node in the study area and corresponding total GDP data, constructing a system dynamics model of the water network system, and solving the system dynamics model to obtain a change curve of GDP with the change of historical construction investment of the node;
step S32: extending the change curve of GDP with the change of historical construction investment of the node based on the system dynamics model until the GDP growth is lower than the node construction investment; setting the GDP increment brought by each 100 million yuan of construction investment as a capacity building efficiency indicator, and obtaining several indicator mutation points on the change curve based on the indicator; and
step S33: screening the optimal indicator mutation point from the several indicator mutation points by using a mutation point monitoring method as the optimal point of the node, i.e., the optimal layout scheme of nodes in the water network system; obtaining the water supply forecast of the node based on the optimal layout scheme of nodes in the water network system.

According to one aspect of the application, the step S4 includes following steps:
step S41: constructing a water resources optimal allocation model, whose objective functions are: minimizing the total water shortage of the system, equalizing the period water shortage rate, and minimizing the cost; constraint conditions include: water balance constraint, water storage constraint, water supply capacity constraint, water demand constraint and non-negativity constraint of variables;
step S42: extracting historical water supply, historical rainfall and historical runoff data of all second-level basins in each first-level basin, inputting them into the water resources optimal allocation model to obtain a historical optimal allocation scheme of the first-level basin;
step S43: constructing an optimization model based on the historical optimal allocation scheme and the corresponding real historical optimal allocation scheme; solving the optimization model by using a reference vector guided evolutionary algorithm (REVA) algorithm optimized based on an improved particle swarm optimization algorithm and chaos mapping to obtain an optimal parameter scheme of the system dynamics model; and
step S44: obtaining the water supply forecast of all second-level basins in the first-level basin based on the sum of water supplies of all nodes in all second-level basins in the first-level basin; inputting the water supply, rainfall and runoff data of all second-level basins in the first-level basin into the optimized system dynamics model to obtain a water resources optimal allocation scheme of the first-level basin.

According to one aspect of the application, the step S43 includes following steps:
step S43a: setting the objective function as minimizing the cumulative deviation between the solved optimal solution and the actual optimal solution based on the historical optimal allocation scheme and the corresponding real historical optimal allocation scheme, and constructing an optimization model; and
step S43b: solving the optimization model by using the optimized REVA algorithm to obtain an optimal parameter scheme of the system dynamics model.

According to one aspect of the application, the step S43b includes following steps:
step S43b1: generating an initial population by using multiple chaos mappings to improve the particle swarm optimization algorithm; calculating optimal basic parameters of the REVA algorithm by using the improved particle swarm optimization algorithm;
step S43b2: generating an initial population of the REVA algorithm by using multiple chaos mappings;
step S43b3: setting a central vector and a preference radius, and generating a preference vector;
step S43b4: generating an offspring population by using traditional genetic operations such as crossover and mutation; then merging the offspring population with the parent population by using an elitist strategy;
step S43b5: generating N sub-populations by associating each population member with one of the N reference vectors;
step S43b6: calculating the angle penalty distance; taking the individual with the smallest APD value in the sub-population as an elite retainer and passing it to the next generation; calculating the i-th adaptive reference vector of the next generation based on a vector adaptation strategy; and
step S43b7: repeating steps S43b4 to S43b6 until a stopping criterion is met, and then outputting the current population as the final result.

According to one aspect of the application, the step S5 includes following steps:
step S51: constructing a water resources optimal scheduling model, whose objective functions include: minimizing the overall water shortage degree and minimizing the water transfer cost; constraint conditions include: water balance constraint, water storage constraint, water supply capacity constraint, water demand constraint and non-negativity constraint of variables;
step S52: sequentially calculating the water supply and demand relationship of the m first-level basins based on their water demands and water supplies; dividing the m first-level basins into three categories according to the supply and demand relationship, the three categories are: supply exceeding demand, supply less than demand, and supply-demand balance;
step S53: respectively calculating the excess water of basins with surplus water and the deficient water of basins with water shortage, inputting them into the water resources optimal scheduling model, and obtaining a non-inferior solution set of the optimal water resources scheduling scheme for the study area by using a multi-objective optimization algorithm; and
step S54: optimizing the non-inferior solution set by using a grey correlation analysis method to obtain the optimal scheduling scheme as the optimal water resources scheduling scheme for the study area; the obtained optimal layout scheme of the water network system includes: the optimal layout scheme of nodes in the water network system, the water resources optimal allocation schemes of the m first-level basins, and the optimal water resources scheduling scheme of the study area.
step S6: monitoring water flow and quality across the water supply network using a plurality of sensor units positioned at predefined locations, each sensor unit generating real-time measurements of water pressure, flow rate, flow direction, and at least one water quality parameter; transmitting the measurements to the server in real-time for integration with the scheduling model.

Beneficial effects: using the method for optimizing the layout of the water network system may support the formation of a national river basin and regional water network optimization layout scheme oriented to medium and long-term water resource security guarantee, put forward suggestions on the layout of major projects and related measures, and reduce project construction costs.

### BRIEF DESCRIPTION OF THE DRAWINGS

FIG. 1A and FIG. 1B are flow charts of the disclosure.

FIG. 2 is a flow chart of step S1 of the disclosure.

FIG. 3 is a flow chart of step S2 of the disclosure.

FIG. 4 is a flow chart of step S3 of the disclosure.

FIG. 5 is a flow chart of step S4 of the disclosure.

### DETAILED DESCRIPTION OF THE EMBODIMENTS

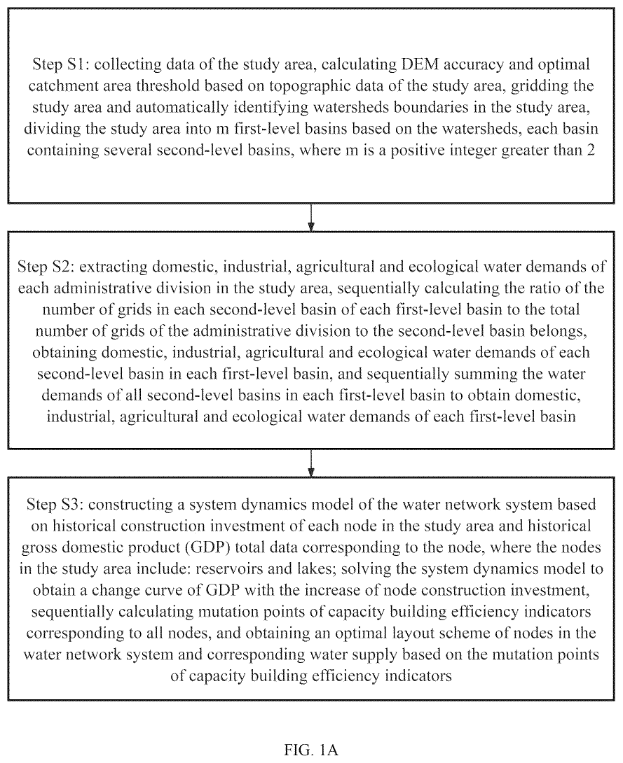

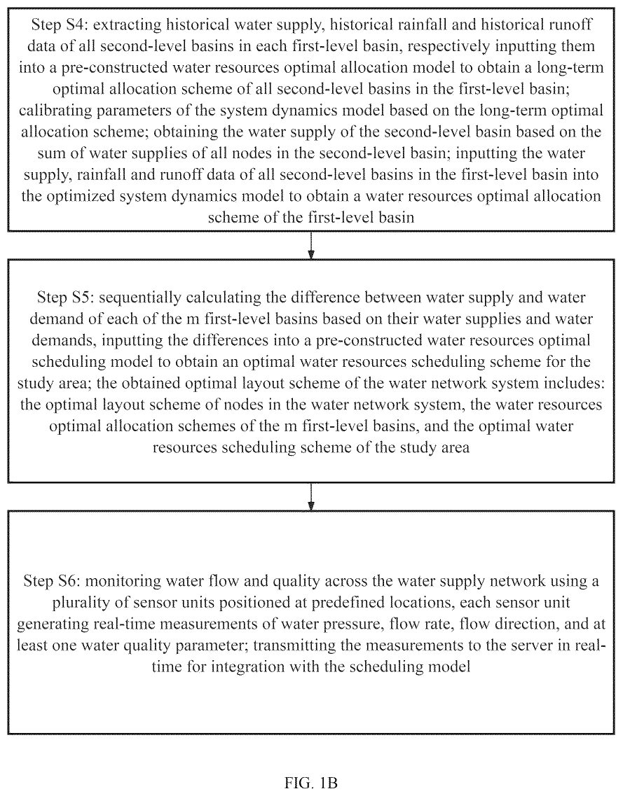

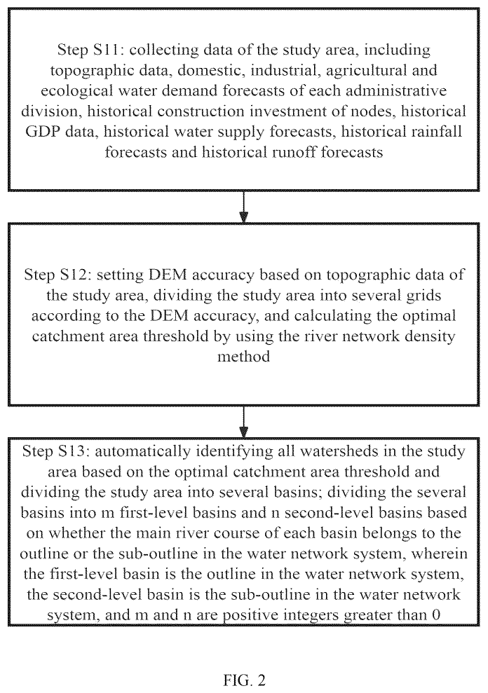

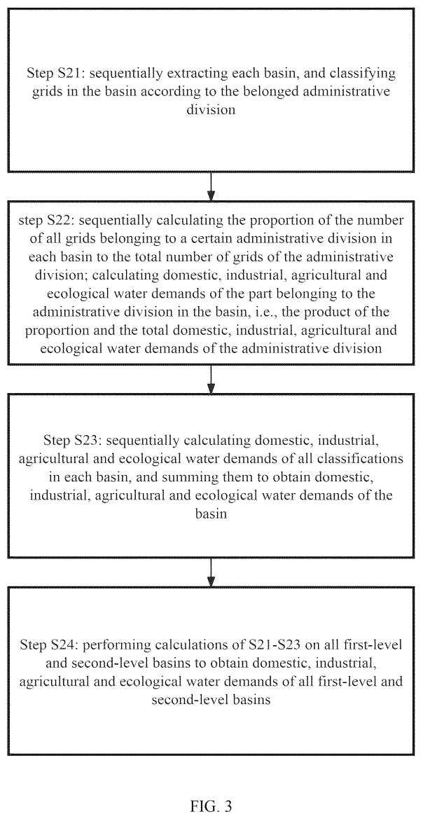

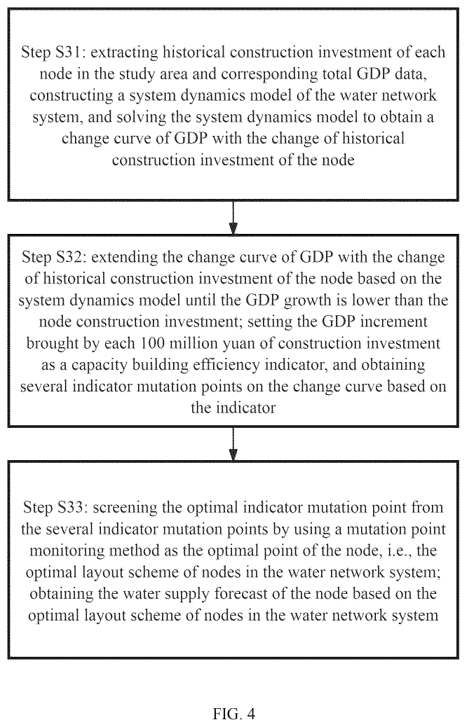

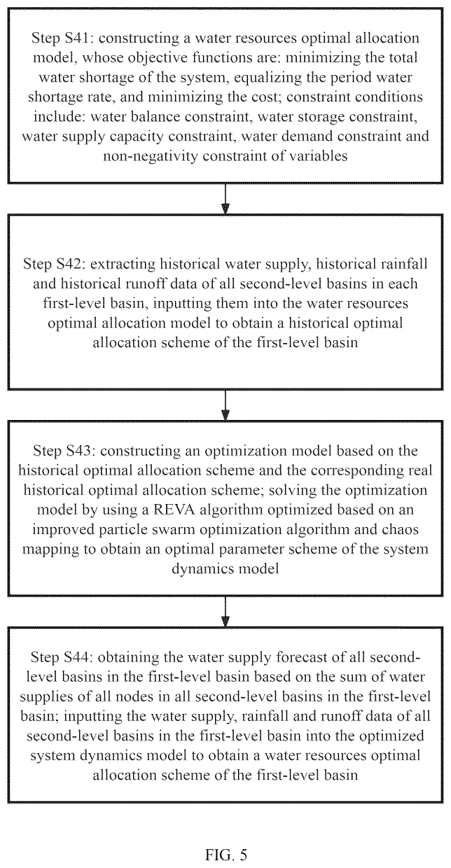

As shown in FIG. 1A and FIG. 1B, the following technical solutions are proposed. According to one aspect of the application, a method for optimizing the layout of a water network system is provided, including following steps:
step S1: collecting data of a study area by using unmanned aerial vehicles (UAVs) equipped with LiDAR sensors and high-resolution multispectral cameras, and from a plurality of ground-based sensor units placed at predefined locations in the water network system, each sensor unit configured to detect surface elevation, soil moisture, and local water level, thereby generating enhanced digital elevation and hydrological response data, calculating digital elevation model (DEM) accuracy and optimal catchment area threshold based on topographic data of the study area, dividing the watersheds into multiple grids, and identifying a water level at each grid cell based on elevation data and surface classification of the grid cell, and automatically identifying watersheds in the study area, dividing the watersheds area into m first-level basins, each basin containing several second-level basins, where m is a positive integer greater than 2;
step S2: extracting domestic, industrial, agricultural and ecological water demands of each administrative division in the study area, sequentially calculating ratio of number of grids in each second-level basin of each first-level basin to the total number of grids of the administrative division to the second-level basin belongs, obtaining domestic, industrial, agricultural and ecological water demands of each second-level basin in each first-level basin, and sequentially summing the water demands of all second-level basins in each first-level basin to obtain domestic, industrial, agricultural and ecological water demands of each first-level basin;
step S3: constructing a system dynamics model of the water network system based on historical construction investment of each node in the study area and historical GDP total data corresponding to the node, where each node in the study area includes: reservoirs and lakes; solving the system dynamics model to obtain a change curve of GDP with the increase of node construction investment, sequentially calculating mutation points of capacity building efficiency indicators corresponding to all nodes, and obtaining an optimal layout scheme of nodes in the water network system and corresponding water supply based on the mutation points of capacity building efficiency indicators;
step S4: extracting historical water supply, historical rainfall and historical runoff data of all second-level basins in each first-level basin, respectively inputting into a pre-constructed water resources optimal allocation model to obtain a long-term optimal allocation scheme of all second-level basins in the first-level basin; calibrating parameters of the system dynamics model based on the long-term optimal allocation scheme; obtaining the water supply of the second-level basin based on the sum of water supplies of all nodes in the second-level basin; inputting the water supply, rainfall and runoff data of all second-level basins in the first-level basin into the optimized system dynamics model to obtain a water resources optimal allocation scheme of the first-level basin; and
step S5: sequentially calculating the difference between water supply and water demand of each of the m first-level basins based on their water supplies and water demands, inputting the differences into a pre-constructed water resources optimal scheduling model to obtain an optimal water resources scheduling scheme for the study area; the obtained optimal layout scheme of the water network system includes: the optimal layout scheme of nodes in the water network system, the water resources optimal allocation schemes of the m first-level basins, and the optimal water resources scheduling scheme of the study area.
step S6: monitoring water flow and quantity across the water supply network using a plurality of sensor units positioned at predefined locations, each sensor unit generating real-time measurements of water pressure, flow rate, flow direction, and at least one water quality parameter; transmitting the measurements to the server in real-time for integration with the scheduling model.

According to one aspect of the application, the step S1 includes following steps:
step S11: collecting data of the study area, including topographic data, domestic, industrial, agricultural and ecological water demand forecasts of each administrative division, historical construction investment of nodes, historical GDP data, historical water supply forecasts, historical rainfall forecasts and historical runoff forecasts;
step S12: setting DEM accuracy based on topographic data of the study area, dividing the study area into several grids according to the DEM accuracy, and calculating the optimal catchment area threshold by using the river network density method; and
step S13: automatically identifying all watersheds in the study area based on the optimal catchment area threshold and dividing the study area into several basins; dividing the several basins into m first-level basins and n second-level basins based on whether the main river course of each basin belongs to the outline or the sub-outline in the water network system, where the first-level basin is the outline in the water network system, the second-level basin is the sub-outline in the water network system, and m and n are positive integers greater than 0.

In extracting digital basin river networks based on DEM, determining the catchment area threshold is crucial for accurately extracting and analyzing the basin and river network structure; different DEM resolutions will lead to different extraction results of digital river networks, which in turn affect the determination of the catchment area threshold; meanwhile, changes in the threshold have uncertain impacts on river network and basin parameters; selecting an appropriate threshold is critical for the accuracy of digital river network and basin extraction; a smaller threshold may extract more small rivers but will increase computational load and data storage requirements; a larger threshold is more suitable for extracting large rivers and may improve computational efficiency; under the same resolution, as the threshold increases, the river network becomes sparse; topographic factors will have a greater impact on the selection of the threshold; and DEM resolution directly affects the extraction and analysis of topographic factors; high-resolution DEM may provide more reliable topographic information, thereby improving the accuracy and precision of results; therefore, different DEM resolutions will affect the selection of the optimal threshold; low-resolution DEM may lead to inaccurate digital river network extraction results, but excessively high resolution is also more susceptible to noise interference.

According to one aspect of the application, the step S12 includes following steps:
step S12a: setting a variety of different DEM resolutions and calculating the river length, basin area and river network density extracted under different thresholds;
step S12b: fitting the second derivative of the river network density curve and finding the point where the second derivative is 0 to obtain the range of the optimal threshold; and
step S12c: superimposing and comparing the river network extracted under the determined optimal threshold range with the actual river network to determine the optimal thresholds under four resolutions.

The optimal catchment area threshold is determined by the trial-and-error method at the beginning; the appropriate threshold was determined by repeatedly testing and comparing the river networks extracted under different thresholds with the real river networks; the trial-and-error method has subjectivity, and has low computational efficiency and accuracy. Subsequently, some researchers proposed more new threshold determination methods based on hydrological information research; the new threshold determination methods include the frequency distribution method of slope flow paths, the moderation index method, the multifractal analysis method, the river network density method and the mean change point analysis method; the river network density method is simple, has the best simulation effect and is widely applicable; therefore, the river network density method is used in the embodiment to determine the optimal catchment area threshold.

According to one aspect of the application, the step S2 includes following steps:
step S21: sequentially extracting each basin, and classifying grids in the basin according to the belonged administrative division;
step S22: sequentially calculating the proportion of the number of all grids belonging to a certain administrative division in each basin to the total number of grids of the administrative division; calculating domestic, industrial, agricultural and ecological water demands of the part belonging to the administrative division in the basin, i.e., the product of the proportion and the total domestic, industrial, agricultural and ecological water demands of the administrative division;
step S23: sequentially calculating domestic, industrial, agricultural and ecological water demands of all classifications in each basin, and summing them to obtain domestic, industrial, agricultural and ecological water demands of the basin; and
step S24: performing calculations of S21-S23 on all first-level and second-level basins to obtain domestic, industrial, agricultural and ecological water demands of all first-level and second-level basins.

According to one aspect of the application, the step S3 includes following steps:
step S31: extracting historical construction investment of each node in the study area and corresponding total GDP data, constructing a system dynamics model of the water network system, and solving the system dynamics model to obtain a change curve of GDP with the change of historical construction investment of the node.

System dynamics is a comprehensive discipline that studies system information feedback and system problems in an intersecting manner; it emphasizes the viewpoints of system, wholeness, connection, development and movement, and may solve interdisciplinary problems such as water resources carrying capacity quantification involving society, economy, ecology and water resources.

System dynamics holds that a system is composed of units and information transmitted through the movement of units; starting from considering the wholeness and nonlinearity of the system, system dynamics describes the complex feedback relationships between various subsystems and substructures; according to the inherent characteristics of the system, on the basis of completely describing the feedback relationships between various subsystems and substructures, the system is divided into several subsystems.

The structure of each subsystem in system dynamics is formed in the form of feedback loops, which are composed of first-order feedback loops; the first-order feedback loops are composed of state variables, rate variables and auxiliary variables; corresponding to the above three variables, three types of equations are set in system dynamics for description, namely state equations, rate equations and auxiliary equations; the main modeling steps for system dynamics to solve problems are:
distinguishing various contradictions existing in the system, clarifying the problems to be solved, and determining the system boundary and system variables;
determining the substructures and feedback loops of the system, and clarifying the connections between various substructures;
determining the flow diagrams and system equations in each feedback link, describing the relationships between qualitative and semi-qualitative variables;
inputting raw data into the model for calculation to obtain the values of each relevant variable and their change charts;
evaluating and analyzing the model operation results, judging whether the simulation results conform to objective reality, and if there is a deviation, finding the cause and correcting the deviation; and
conducting historical testing and sensitivity analysis on the model, making final adjustments to variable parameters, and providing a scientific basis for future decision-making and regulation.

Step S32: extending the change curve of GDP with the change of historical construction investment of the node based on the system dynamics model until the GDP growth is lower than the node construction investment; setting the GDP increment brought by each 100 million yuan of construction investment as a capacity building efficiency indicator, and obtaining several indicator mutation points on the change curve based on the indicator.

In the embodiment, by constructing a system dynamics model of the water network system, improving the construction of water conservancy project capabilities may bring an increase in available water resources, which will bring about social and economic growth; in the embodiment, GDP growth is directly used to represent social and economic growth; meanwhile, as capacity construction increases, the GDP growth trend will slow down due to marginal benefits; the GDP increment brought by each 100 million yuan of capacity construction is set as the capacity building efficiency indicator; the mutation point of this indicator is found as the optimization point of the node; while optimizing the node, the water resources supply forecast of the second-level basin is obtained.

step S33: screening the optimal indicator mutation point from the several indicator mutation points by using a mutation point monitoring method as the optimal point of the node, i.e., the optimal layout scheme of nodes in the water network system; obtaining the water supply forecast of the node based on the optimal layout scheme of nodes in the water network system.

According to one aspect of the application, the step S4 includes following steps:
step S41: constructing a water resources optimal allocation model, whose objective functions are: minimizing the total water shortage of the system, equalizing the period water shortage rate, and minimizing the cost; constraint conditions include: water balance constraint, water storage constraint, water supply capacity constraint, water demand constraint and non-negativity constraint of variables;
step S42: extracting historical water supply, historical rainfall and historical runoff data of all second-level basins in each first-level basin, inputting them into the water resources optimal allocation model to obtain a historical optimal allocation scheme of the first-level basin;
step S43: constructing an optimization model based on the historical optimal allocation scheme and the corresponding real historical optimal allocation scheme; solving the optimization model by using a reference vector guided evolutionary algorithm (REVA) algorithm optimized based on an improved particle swarm optimization algorithm and chaos mapping to obtain an optimal parameter scheme of the system dynamics model;
step S44: obtaining the water supply forecast of all second-level basins in the first-level basin based on the sum of water supplies of all nodes in all second-level basins in the first-level basin; inputting the water supply, rainfall and runoff data of all second-level basins in the first-level basin into the optimized system dynamics model to obtain a water resources optimal allocation scheme of the first-level basin.

After obtaining the water supply forecasts of all second-level basins in the previous step, since the water resources allocation scheme directly obtained by using the system dynamics model is more a generalization and description of historical situations, it is not as good as the scheme directly obtained by using the water resources allocation model; therefore, in the embodiment, historical data are first extracted and input into the water resources allocation model to obtain a historical allocation scheme; then the predicted historical allocation scheme is compared with the real historical allocation scheme to optimize the system dynamics model, so as to improve the accuracy of the model; then the optimized system dynamics model is used to simulate the water supply scheme; the obtained water supply scheme is more scientific and accurate compared with the water supply schemes obtained by using the two models alone.

According to one aspect of the application, the step S43 includes following steps:
step S43a: setting the objective function as minimizing the cumulative deviation between the solved optimal solution and the actual optimal solution based on the historical optimal allocation scheme and the corresponding real historical optimal allocation scheme, and constructing an optimization model; and
step S43b: solving the optimization model by using the optimized REVA algorithm to obtain an optimal parameter scheme of the system dynamics model.

According to one aspect of the application, the step S43b includes following steps:
step S43b1: constructing a mapping set by using Henon mapping, Lorenz mapping, Tent mapping, Arnold mapping, Rossler mapping and Koopman mapping with excellent ergodicity; randomly extracting mappings from the mapping set by using a random algorithm to generate an initial population when generating the initial population by the particle swarm optimization algorithm, so as to further improve the randomness of the initial population while maintaining excellent ergodicity of the initial population, and improve algorithm efficiency and robustness; calculating optimal basic parameters of the REVA algorithm by using the improved particle swarm optimization algorithm;
step S43b2: constructing a mapping set by using Henon mapping, Lorenz mapping, Tent mapping, Arnold mapping, Rossler mapping and Koopman mapping with excellent ergodicity; randomly extracting mappings from the mapping set by using a random algorithm to generate an initial population when generating the initial population by the REVA algorithm, so as to further improve the randomness of the initial population while maintaining excellent ergodicity of the initial population, and improve algorithm efficiency and robustness;
step S43b3: setting a central vector and a preference radius, and generating a preference vector;
step S43b4: generating an offspring population by using traditional genetic operations such as crossover and mutation; then merging the offspring population with the parent population by using an elitist strategy;
step S43b5: generating N sub-populations by associating each population member with one of the N reference vectors;
step S43b6: calculating the angle penalty distance; taking the individual with the smallest APD value in the sub-population as an elite retainer and passing it to the next generation; calculating the i-th adaptive reference vector of the next generation based on a vector adaptation strategy; and
step S43b7: repeating steps S43b4 to S43b6 until a stopping criterion is met, and then outputting the current population as the final result.

According to one aspect of the application, the step S5 includes following steps:
step S51: constructing a water resources optimal scheduling model, whose objective functions include: minimizing the overall water shortage degree and minimizing the water transfer cost; constraint conditions include: water balance constraint, water storage constraint, water supply capacity constraint, water demand constraint and non-negativity constraint of variables;
step S52: sequentially calculating the water supply and demand relationship of the m first-level basins based on their water demands and water supplies; dividing the m first-level basins into three categories according to the supply and demand relationship, which are: supply exceeding demand, supply less than demand, and supply-demand balance;
step S53: respectively calculating the excess water of basins with surplus water and the deficient water of basins with water shortage, inputting them into the water resources optimal scheduling model, and obtaining a non-inferior solution set of the optimal water resources scheduling scheme for the study area by using a multi-objective optimization algorithm; and
step S54: optimizing the non-inferior solution set by using a grey correlation analysis method to obtain the optimal scheduling scheme as the optimal water resources scheduling scheme for the study area; the obtained optimal layout scheme of the water network system includes: the optimal layout scheme of nodes in the water network system, the water resources optimal allocation schemes of the m first-level basins, and the optimal water resources scheduling scheme of the study area.
Step S55: controlling real-time water distribution in the water network system based on the optimal water resources scheduling scheme through a plurality of adjustable gates located within a plurality of water channels, wherein each adjustable gate is actuated to regulate water flow based on control signals generated in response to flow data collected by a corresponding flow sensor positioned in the respective water channel, and wherein a plurality of flow monitoring stations receive the flow data from the sensors and transmit the control signals to the respective adjustable gates.

Grey correlation analysis is a method used to study the correlation degree of uncertain systems, which is often used in fields such as multi-factor decision-making problems, evaluation index selection and quality analysis; this method is based on grey system theory, and reveals the internal connections and laws by analyzing the correlation degree between data.

Firstly, determining multiple factors or indicators to be evaluated, and expressing them as time series or data matrices;
standardizing the original data of each evaluation factor to make the processed data comparable;
calculating the correlation coefficient between each factor;
calculating the correlation degree between each factor by using the grey correlation factor method; the larger the correlation degree value, the higher the correlation degree between factors; and
determining the optimal factor or factor combination based on the calculated correlation degree value.

Based on grey system theory, grey correlation analysis may well handle situations with incomplete or uncertain information, making the analysis closer to the actual situation; grey correlation analysis has lower requirements on the sample size of data, and may perform effective analysis even with a small amount of data; this method is suitable for correlation analysis between multiple factors, may comprehensively consider the influence degree between multiple factors, reveal the internal connections between factors as a whole, and provide more comprehensive information; compared with other methods, grey correlation analysis has better flexibility in data processing, which helps to better specify decision-making schemes; therefore, in the embodiment, the grey correlation analysis method is used to make decisions on the non-inferior solution set obtained in the previous step, and select the optimal scheme.

Through steps S3-S4, the water resources within each basin are optimized; at this time, the water gap between basins may only be balanced through water transfer between basins; therefore, in the embodiment, water transfer is carried out between basins in the study area by calculating whether the water supply and demand of each basin are balanced, so as to realize the optimal layout of the entire water network system; the obtained optimal layout scheme includes: the optimal layout scheme of nodes in the water network system, the water resources optimal allocation schemes of the m basins, and the optimal water resources scheduling scheme of the study area.

In the disclosure, firstly, the optimal point is found through the relationship between the construction investment of nodes in the water network system and regional GDP; the nodes are optimized, and the water supply of each node is obtained at the same time; the water supply of the sub-basin is obtained by summing the water supplies of all nodes in the sub-basin; the water resources of each basin are allocated based on the supply and demand relationship of sub-basins in each basin, so as to obtain the optimal allocation scheme between sub-basins in each basin; then, water transfer between basins in the study area is carried out according to whether each basin is short of water or has surplus water, so as to achieve the optimal layout of the water network system; the obtained optimal layout scheme includes: the optimal layout scheme of nodes in the water network system, the water resources optimal allocation schemes of the m basins, and the optimal water resources scheduling scheme of the study area.

According to another aspect of the application, a system for optimizing layout of water network system is provided, which includes:
at least one processor; and
a memory communicatively connected to the at least one processor;
where the memory stores instructions executable by the processor, and the instructions are used to be executed by the processor to implement the method for optimizing the layout of a water network system according to any one of the above.

The preferred embodiments of the disclosure have been described in detail above, but the disclosure is not limited to the specific details in the above embodiments; within the technical concept of the disclosure, various equivalent transformations may be made to the technical solutions of the disclosure, and these equivalent transformations all belong to the protection scope of the disclosure.

What is claimed is:

1. A method for optimizing a layout of a water network system, comprising following steps:
step S1: collecting data of a study area, calculating digital elevation model (DEM) accuracy and optimal catchment area threshold based on topographic data of the study area, gridding the study area and automatically identifying watersheds in the study area, dividing the study area into m first-level basins based on the watersheds, each basin comprising a plurality of second-level basins, wherein the m is a positive integer greater than 2;
step S2: extracting domestic, industrial, agricultural and ecological water demands of each administrative division in the study area, sequentially calculating ratios of a number of grids in each second-level basin of each first-level basin to total number of grids of the administrative division comprising the second-level basin to obtain domestic, industrial, agricultural and ecological water demands of each second-level basin in each first-level basin, and sequentially summing the water demands of all second-level basins in each first-level basin to obtain domestic, industrial, agricultural and ecological water demands of each first-level basin;
step S3: constructing a system dynamics model of the water network system based on a historical construction investment of each node in the study area and historical gross domestic product (GDP) total data corresponding to the node, wherein the each node in the study area comprises: reservoirs and lakes; solving the system dynamics model to obtain a change curve of GDP with an increase of node construction investment, sequentially calculating mutation points of capacity building efficiency indicators corresponding to all nodes, and obtaining an optimal layout scheme of nodes in the water network system and corresponding water supply based on the mutation points of capacity building efficiency indicators;
step S4: extracting historical water supplies, historical rainfall and historical runoff data of all the second-level basins in each first-level basin, respectively inputting extracted data into a pre-constructed water resources optimal allocation model to obtain a long-term optimal allocation scheme of all the second-level basins in the first-level basin; calibrating parameters of the system dynamics model based on the long-term optimal allocation scheme; obtaining a water supply of the second-level basins based on a sum of the water supplies of all nodes in the second-level basins; inputting the water supplies, rainfall and runoff data of all the second-level basins in the first-level basin into an optimized system dynamics model to obtain a water resources optimal allocation scheme of the first-level basin; and
step S5: sequentially calculating a difference between water supplies and water demands of each basin based on water supplies and water demands of the m first-level basins, inputting the differences into a pre-constructed water resources optimal scheduling model to obtain an optimal water resources scheduling scheme for the study area; an obtained optimal layout scheme of the water network system comprising: the optimal layout scheme of the nodes in the water network system, the water resources optimal allocation schemes of the m first-level basins, and the optimal water resources scheduling scheme of the study area;
wherein the step S1 comprises following steps:
step S11: collecting the data of the study area, comprising the topographic data, the domestic, industrial, agricultural and ecological water demands forecasts of each administrative division, the historical construction investment of the nodes, historical GDP data, historical water supply forecasts, historical rainfall forecasts and historical runoff forecasts;
step S12: setting the DEM accuracy based on the topographic data of the study area, dividing the study area into a plurality of grids according to the DEM accuracy, and calculating the optimal catchment area threshold by using a river network density method; and
step S13: automatically identifying all the watersheds in the study area based on the optimal catchment area threshold and dividing the study area into a plurality of basins; dividing the plurality of basins into m first-level basins and n second-level basins based on whether main river courses of each basin belong to an outline or a sub-outline in the water network system, wherein the first-level basin is the outline in the water network system, and the second-level basin is the sub-outline in the water network system, wherein m and n are positive integers greater than 0;
wherein the step S12 comprises following steps:
step S12a: setting a variety of different DEM resolutions and calculating river lengths, basin areas and river network densities extracted under different thresholds;
step S12b: fitting a second derivative of a river network density curve and finding a point, wherein the second derivative of the point is 0, and obtaining a range of an optimal threshold; and
step S12c: superimposing and comparing river networks extracted under a determined optimal threshold range with actual river networks to determine an optimal threshold under four resolutions;
wherein the step S3 comprises following steps:
step S31: extracting the historical construction investments of each node in the study area and corresponding total GDP data, constructing the system dynamics model of the water network system, and solving the system dynamics model to obtain a change curve of the GDP with a change of historical construction investment of the node;
step S32: extending the change curve of the GDP with the change of historical construction investment of the node based on the system dynamics model until a GDP growth is lower than the construction investment of the node; setting a GDP increment brought by each 100 million yuan of construction investment as a capacity building efficiency indicator, and obtaining a plurality of indicator mutation points on the change curve based on the indicator; and
step S33: screening an optimal indicator mutation point from the plurality of indicator mutation points by using a mutation point monitoring method as an optimal point of the node, namely, the optimal layout scheme of the nodes in the water network system; obtaining water supplies forecast of the node based on the optimal layout scheme of the nodes in the water network system;
wherein the step S4 comprises following steps:
step S41: constructing a water resources optimal allocation model, wherein objective functions of the model are: total water shortage of the system is the smallest, and a water shortage rate is uniform and cost is the smallest; and constraint conditions comprise: water balance constraint, water storage constraint, water supply capacity constraint, water demand constraint and non-negativity constraint of variables;
step S42: extracting the historical water supply, historical rainfall and historical runoff data of all the second-level basins in each first-level basin, and inputting the extracted data into the water resources optimal allocation model to obtain a historical optimal allocation scheme of the first-level basin;
step S43: constructing an optimization model based on the historical optimal allocation scheme and a corresponding real historical optimal allocation scheme; solving the optimization model by using a reference vector guided evolutionary algorithm (REVA) optimized based on an improved particle swarm optimization algorithm and chaos mapping to obtain an optimal parameter scheme of the system dynamics model; and
step S44: obtaining a water supply forecast of all the second-level basins in the first-level basin based on the sum of water supplies of all the nodes in all the second-level basins in the first-level basin; inputting water supply, rainfall and runoff data of all the second-level basins in the first-level basin into the optimized system dynamics model to obtain the water resources optimal allocation scheme of the first-level basin;
wherein the step S43 comprises following steps:
step S43a: setting an objective function as minimizing a cumulative deviation between a solved optimal solution and an actual optimal solution based on the historical optimal allocation scheme and the corresponding real historical optimal allocation scheme, and constructing an optimization model; and
step S43b: solving the optimization model by using the optimized REVA to obtain the optimal parameter scheme of the system dynamics model;
wherein the step S43b comprises following steps:
step S43b1: generating an initial population by using multiple chaos mappings to improve the particle swarm optimization algorithm; and calculating optimal basic parameters of the REVA by applying an improved particle swarm optimization algorithm;
step S43b2: generating an initial population of the REVA by using multiple chaos mappings;
step S43b3: setting a central vector and a preference radius, and generating a preference vector;
step S43b4: generating an offspring population by using traditional genetic operations such as crossover and mutation; then merging the offspring population with a parent population by using an elitist strategy;
step S43b5: generating N sub-populations by associating each population member with one of N reference vectors;
step S43b6: calculating an angle penalty distance (APD); taking an individual with a smallest APD value in the sub-population as an elite retainer and passing to a next generation; calculating an i-th adaptive reference vector of the next generation based on a vector adaptation strategy; and
step S43b7: repeating the step S43b4 to the step S43b6 until a stopping criterion is met, and then outputting a current population as a final result;
wherein the step S5 comprises following steps:
step S51: constructing a water resources optimal scheduling model, wherein objective functions comprise: overall water shortage is the lowest and water transfer cost is the lowest; and constraint conditions comprise: water balance constraint, water storage constraint, water supply capacity constraint, water demand constraint and non-negativity constraint of variables;
step S52: sequentially calculating a supply and demand relationship of water resources in the m first-level basins based on water demands and water supplies of the first-level basins; and dividing the m first-level basins into three categories according to the supply and demand relationship, the three categories are: supply exceeding demand, supply less than demand, and supply-demand balance;
step S53: respectively calculating excess water of basins with surplus water and deficient water of basins with water shortage, and inputting into the water resources optimal scheduling model, and obtaining a non-inferior solution set of the optimal water resources scheduling scheme for the study area by using a multi-objective optimization algorithm; and
step S54: optimizing the non-inferior solution set by using a grey correlation analysis method to obtain an optimal scheduling scheme as the optimal water resources scheduling scheme for the study area; the obtained optimal layout scheme of the water network system comprises: the optimal layout scheme of the nodes in the water network system, the water resources optimal allocation schemes of the m first-level basins, and the optimal water resources scheduling scheme of the study area.

2. The method for optimizing the layout of the water network system according to claim 1, wherein the step S2 comprises following steps:
step S21: sequentially extracting each basin, and classifying grids in the basin according to the belonged administrative division;
step S22: sequentially calculating a proportion of a number of all grids belonging to a certain administrative division in each basin to a total number of grids of the certain administrative division; calculating domestic, industrial, agricultural and ecological water demands of a proportion belonging to the administrative division in the basin, namely, a product of the proportion and total domestic, industrial, agricultural and ecological water demands of the administrative division;
step S23: sequentially calculating domestic, industrial, agricultural and ecological water demands of all classifications in each basin, and summing to obtain domestic, industrial, agricultural and ecological water demands of the basin; and
step S24: performing calculations of the S21-S23 on all the first-level and second-level basins to obtain domestic, industrial, agricultural and ecological water demands of all the first-level and second-level basins.
